(19) United States
(12) Patent Application Publication
(10) Pub. No.: US 2002/0110123 A1
(43) Pub. Date: Aug. 15, 2002

(54) Network connection control apparatus and method

(76) Inventor: Kazuhiro Shitama, Chiba (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/045,320

(22) Filed: Nov. 9, 2001

(30) Foreign Application Priority Data
Nov. 10, 2000 (JP) P2000-343429

(51) Int. Cl. H04L 12/28

(52) U.S. Cl. 370/389; 370/401

(57) ABSTRACT

A network connection control apparatus and method are provided for granting access to an authenticated device on a global network to a device on a local network, wherein the access permission setting can be automatically controlled. The network connection control apparatus comprises an access control unit which authenticates the device on the global network which transmitted an access request, creates an access permission entry for the authenticated device, and adds the entry to an access permission list. Upon receiving a data packet from the device on the global network, the access control unit determines whether the data packet should be transferred to the local network on the basis of access information extracted from the data packet and the information about the access permission entry contained in the access permission list.

### BACKGROUND OF THE INVENTION

1. Field of the Invention

The present invention relates to an apparatus and a method for controlling the granting of access when a device on a global network demands access to services provided on a local network.

2. Description of the Prior Art

The spread of networks has brought with it an increasing number of their users. There is also an increasing number of service providers providing various information data on the networks. While this makes it easier for people to obtain necessary information via the networks, more and more administrators of the networks are complaining about damage caused by unauthorized accesses. A gateway is an effective means of ensuring security of a server or a terminal device connected with a local network. The gateway has a firewall function by which access to the local network called LAN (local area network) such as Home Network from a global network called WAN (wide area networks), such as the Internet, is granted or denied.

Usually, a device on the local network accesses a network device such as a server on a particular global network providing certain information via the gateway connected between the global network and the local network. The gateway is assigned a global address for use by the global network and a local address for use by the local network. The gateway is also provided with communication ports for carrying out data communications between the global network and the local network.

As mentioned above, the gateway has the firewall for preventing illegal access from the global network such as the Internet. The firewall statically controls the granting or denying of individual access requests from the Internet on an individual policy according to the system setting. The statical setting is such that access is granted only to especially authorized accessing parties in a default state. Thus, resources in the terminal devices such as the individual servers on the local network can be prevented from being destroyed or having their secret contents leaked by external illegal access.

However, the downside of such a measure by statical setting on firewall is that valid access requests may also be rejected, thereby harming the convenience with which the device on the global network can access the device on the local network.

Japanese Unexamined Patent Application Publication No. 11-338799 discloses an improved firewall technique by which access requests from the outside can be easily checked to distinguish illegal accesses from valid ones while ensuring the security of the local network. In this technique, when a device on the global network demands access to a device on the local network, such as a server providing certain services (to be hereafter referred to as a local server), the global network device first downloads a transfer code from the gateway of the local network which is necessary for accessing the local server. The downloaded transfer code is processed in the global network device to create a relay agent, via which access can be made to the local server.

This method allows the convenience with which the device on the global network can access the local server to be improved while maintaining the same level of security as by the conventional method using the firewall.

This method, however, has the disadvantage that the transfer code must be downloaded prior to accessing the local server. In addition, an environment for processing the transfer code in order to create the transfer agent must be provided on the global network device.

### SUMMARY OF THE INVENTION

It is an object of the present invention to provide an apparatus and a method for controlling the network connection whereby authenticated devices on the global network are granted access to devices on the local network, and whereby the access granting setting can be dynamically controlled.

To achieve this objective, the present invention provides a network connection control apparatus for granting or denying access when a device on a global network demands access to services provided on a local network. The network connection control apparatus comprises authentication means for authenticating the device on the global network, access permission entry creating means for creating an access permission entry in response to an access request from the device authenticated by the authentication means and adding the access permission entry to an access permission list, and control means for determining, upon reception of a data packet from the device on the global network, whether or not the data packet should be transferred to the local network based on information extracted from the header of the data packet and on the access permission entry contained in the access permission list.

In a preferred embodiment of the present invention, the entry creating means extracts access information from an access request packet transmitted from the authenticated device, and creates an access permission entry which contains a source IP address, a destination IP address, a source port number, a destination port number and a last access permission time.

In a further preferred embodiment of the present invention, the control means extracts a source IP address, a port number, a destination IP address and a port number from the header of the data packet transmitted from the device on the global network. The control means then compares the thus extracted information with the information about access permission entry contained in the access permission list. If the extracted information and the access permission entry information correspond in all of the source IP address, destination IP address, source port number and destination port number, the control means transfers the data packet to the local network.

In a further preferred embodiment of the present invention, the control means eliminates a relevant access permission entry from the access permission list in response to an access termination notification from the device on the global network.

In a yet further preferred embodiment of the present invention, the control means calculates the duration of time that elapsed since the last access was made based on a last access permission time stored in the access permission entry which corresponds to the time at which the data packet was received from the global network device. When the elapsed time exceeds a predetermined reference time, the control means eliminates the relevant access permission entry from the access permission list.

The present invention also provides a network connection control method for granting or denying access when a device on a global network demands access to services provided on a local network. The network connection control method comprises the steps of authenticating the device on the global network, creating an access permission entry in response to an access request made by the authenticated device and adding the created access permission entry to an access permission list, and determining, upon receiving a data packet from the global network device, whether or not the data packet should be transferred to the local network based on information extracted from the header of the data packet and on the access permission entry contained in the access permission list.

In a preferred embodiment of the present invention, the step of creating the access permission entry involves extracting access information from an access request packet transmitted from the authenticated device, whereby an access permission entry is created which contains a source IP address, a destination IP address, a source port number, a destination port number and a last access permission time.

In a further preferred embodiment of the present invention, the source IP address, the source port number, the destination IP address and the destination port number are extracted from the header of the data packet transmitted from the device on the global network. The thus extracted items of information are compared with information about the access permission entry contained in the access permission list. The data packet is transferred to the local network side if the extracted information and the access permission entry information correspond in all of the source IP address, the destination IP address, the source port number and the destination port number.

### BRIEF DESCRIPTION OF THE DRAWINGS

The present invention will be hereafter described by way of a preferred embodiment with reference made to the attached drawings, in which:

FIG. 1 is a schematic representation of a network system including a network connection control apparatus (gateway) according to the present invention;

FIG. 2 is a block diagram of the structure of the gateway;

FIG. 3 is a flowchart of the operation of an access control unit when it received an access request from a device on a global network;

FIG. 4 is a table showing an example of an access permission entry;

FIG. 5 is a flowchart of the operation of the access control unit when it received a data packet from the global network;

FIG. 6 is a flowchart of a processing for eliminating the access permission entry based on a last permission time and a threshold time; and

FIG. 7 is a flowchart of a processing for eliminating the access permission entry in response to an access termination notice issued by the accessing party.

### DESCRIPTION OF A PREFERRED EMBODIMENT

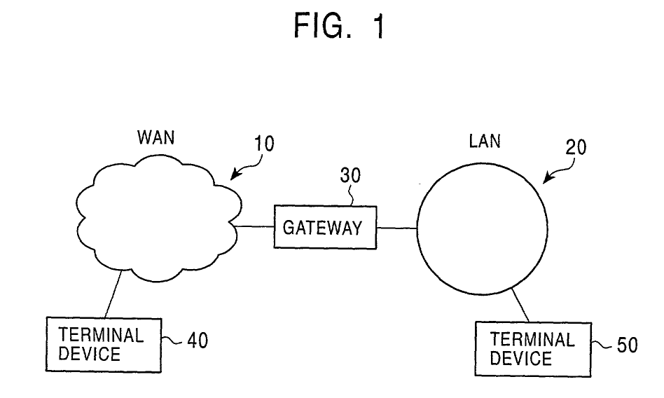

FIG. 1 shows an example of a network system including a network connection control apparatus according to the present invention.

The network system comprises a global network WAN (wide area network) 10, a local network LAN (local area network) 20, a gateway 30 connected between the global network 10 and the local network 20, a terminal device 40 connected to the global network 10 and a terminal device 50 connected to the local network 20.

The gateway 30 constitutes the so-called network connection control apparatus having the firewall function which, upon receiving an access request from the terminal device on the global network 10 for services provided on the local network 20, grants access only when the terminal device is authenticated.

Though in FIG. 1, one terminal device is connected to each of the global network 10 and the local network 20, usually a number of terminal devices are connected to each of them in the actual network system.

The gateway 30 has a firewall feature which normally denies access from the terminal device on the global network 10 to the one on the local network 20.

Within the local network 20, private IP addresses are assigned to each terminal devices, while at least one global IP address is assigned to the global network connection interface of the gateway 30. The each terminal devices on the local network 20 can access services provided on the global network by means such as the IP masquerade technique.

The network connection control apparatus according to the present invention has a dynamically adaptable firewall setting, whereby access to designated services on the local network 20 is granted only to an authenticated one or ones of the terminal devices connected to the global network 10 in response to access requests from them, while denying access to the other unauthenticated devices on the global network.

In the following description, the message notifying the gateway 30 of the service requested by the terminal device on the global network 10 will be referred to as “a service access request message”. Since private IP addresses are used on the local network 20, individual port numbers are assigned on the gateway 30 to each service, so that the services provided on the local network 20 can be specified by the device on the global network 20. Thus, the device on the global network 10 can access desired services by specifying the global IP address and port number on the global network-side interface in the gateway 30.

The IP address and the port number with which the device on the global network specifies the services on the local network will be referred to as “a service IP address”and “a service port number”, respectively. When the device on the global network demands access to the device on the local network, the service IP address and the service port number are stored into the service access request message and transmitted to the gateway 30.

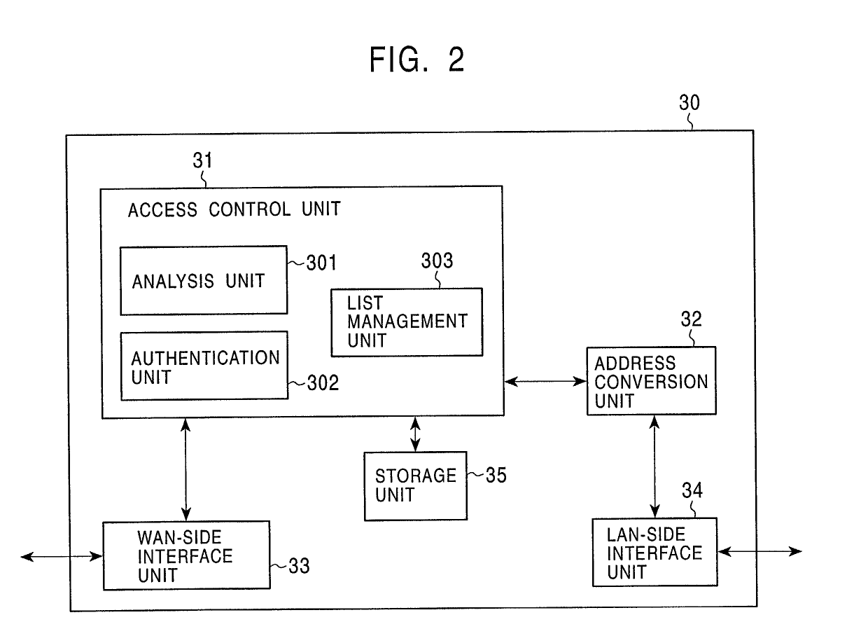

FIG. 2 shows a block diagram of the structure of the gateway 30. In the following, the structure and function of each part of the gateway 30 will be described by referring to FIG. 2.

As shown, the gateway 30 comprises an access control unit 31, an address conversion unit 32, a global network-(WAN-) side interface unit 33, a local network- (LAN-) side interface unit 34 and a storage unit 35. The access control unit 31 further comprises an analysis unit 301, an authentication unit 302 and a list management unit 303.

The access control unit 31 analyzes the service access request message received from the global network, authenticates the device and manages an access permission list. Depending on the result of analysis and authentication, the access control unit 31 grants or denies access to a data packet received from the global network.

The individual parts of the access control unit 31 will be described in the following.

The analysis unit 301 extracts and analyzes necessary information from the service access request message received via the WAN-side interface unit 33. For example, when the device on the global network transmits the service access request message to access the device on the local network, the message is received by the WAN-side interface unit 33 and then passed over to the access control unit 31. The analysis unit 301 in the access control unit 31 extracts from the received service access request message information about a source IP address, a source port number, a service IP address and a service port number, for example. Based on these items of information, an access permission entry is created and sent to the list management unit 303.

The analysis unit 301 also extracts information about source and destination IP addresses, port numbers, etc., from the header of the data packet received via the WAN-side interface unit 33. Based on the thus extracted information and the information about the access permission entry contained in the access permission list, the analysis unit 301 determines whether access should be granted or denied.

Upon receiving the service access request message from the device on the global network 10, the authentication unit 302 authenticates the device according to a predetermined authentication method and procedure. The authentication unit 301 then transmits the information about the authenticated device to the analysis unit 301, where the access permission entry for the access request in question is created.

The list management unit 303 receives the access permission entry created by the analysis unit 301 and adds it to the access permission list stored in the storage unit 35. When the access is terminated, the list management unit 303 eliminates the relevant access permission entry from the access permission list stored in the storage unit 35.

The address conversion unit 32 is necessary only when a private IP address (a local IP address) is used on the local network 20. Specifically, the address conversion unit 32 converts between the global IP address used on the global network 10 and the local IP address used on the local network 20.

The WAN-side interface 33 transmits and receives packets to and from the global network 10. Specifically, the WAN-side interface 33 receives a packet from the global network 10 and sends it to the access control unit 31, while transmitting a packet from the access control unit 31 to the global network 10.

The LAN-side interface unit 34 transmits and receives packets to and from the local network 20. Specifically, the LAN-side interface unit 34 receives a packet from the local network 20 and sends it to the address conversion unit 32, while transmitting a packet sent from the address conversion unit 32 to the local network 20.

The storage unit 35 stores the access permission list. The access permission list is managed by the list management unit 303 in the access control unit 31. The access permission entry created by the analysis unit 301 is added to the access permission list, and the access permission entry corresponding to a terminated access is eliminated from the access permission list.

In the following, the operation of the access control unit 31 of the gateway 30 will be described.

The following description concerns the case where the access control unit 31 received the service access request message containing the service IP address and the service port number from the device on the global network 10.

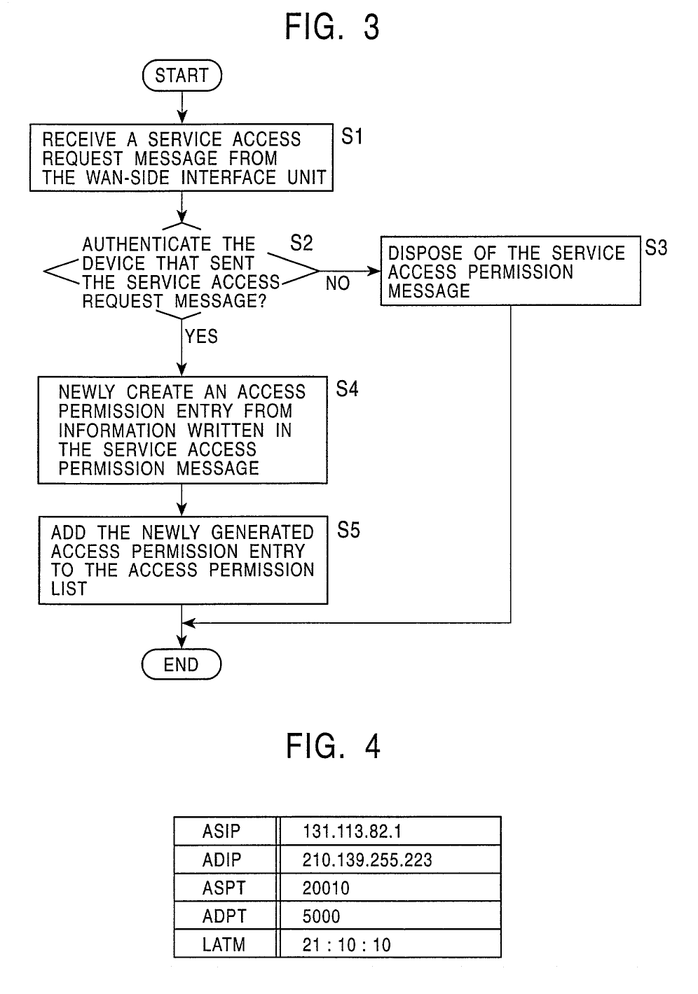

FIG. 3 shows a flowchart of the operation of the access control unit 31 upon receiving the service access request message.

As shown, the service access request message is received via the WAN-side interface unit 33 in step S1.

In step S2, the source IP address and the source port number contained in the IP header of the received service access request message, indicating the transmitting device, are confirmed, and the device which transmitted the service access request message is authenticated. The method of authentication of the transmitting device is not particularly limited in the present invention, for it may be done by various known methods such as by IPsec AH and a third-party authentication scheme such as Kerberos.

If the authentication was unsuccessful, the service access request message is disposed of in step S3, and the procedure ends.

If the authentication was successful, four items of information are extracted from the service access request message, including the IP header source address, the TCP/UDP header source port number, the service IP address number described in the payload and the service port number described in the payload.

In step S4, the access permission entry is created by storing these four items of information in four storage fields including an authorized source IP address field (ASIP), an authorized destination IP address field (ADIP), an authorized source port number field (ASPT) and an authorized destination port number field (ADPT).

In addition to those four fields, the access permission entry also has a last access permission time field (LATM) for storing the time at which a packet was last relayed from the global network 10 to the local network 20 using the present entry. When an access permission entry is newly created, the time at which it was created is stored in the relevant field.

In step S5, the thus created access permission entry is added to the access permission list.

FIG. 4 shows an example of the access permission entry created by the above processing. As shown, in this entry, the authorized source IP address field (ASIP) has stored therein the global IP address of the device that sent the service access request message, such as 131.113.82.1. The authorized destination IP address field (ADIP) has stored therein the service IP address of the payload of the service access request message, such as a global IP address 210.139.255.223 assigned to the WAN-side interface unit 33 of the gateway 30. The authorized source port number field (ASPT) has stored therein the port number of the device that sent the service access request message, such as 20010. The authorized destination port number field (ADPT) has stored therein the service port number of the payload of the service access request message, such as 5000. The last access permission time field (LATM) has stored therein the time at which the entry was created, such as 21:10:10.

The access permission entry shown in FIG. 4 is added to the access permission list, which is managed by the access control unit 31 and stored in the storage unit 35, for example.

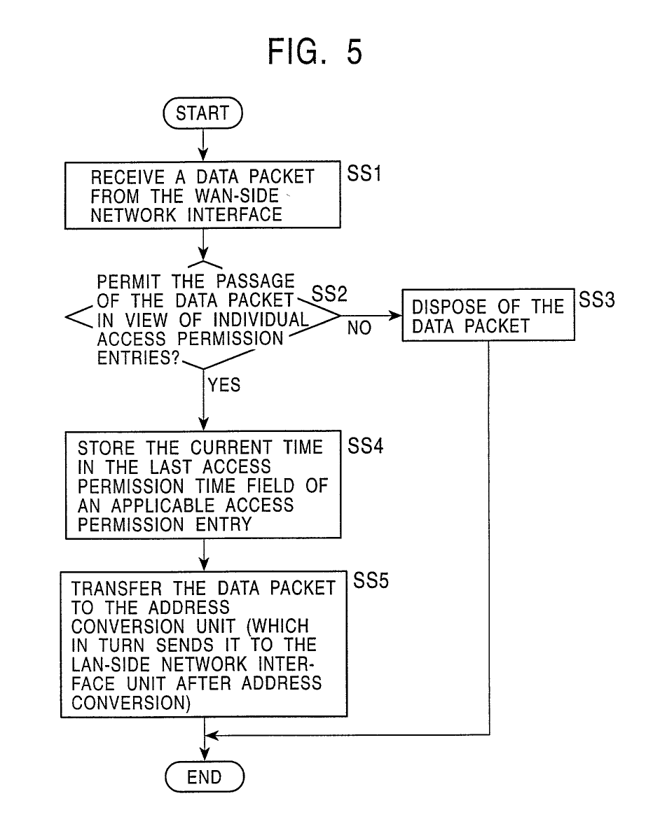

In the following, the operation of the access control unit 33 upon receiving a data packet from the global network 10 will be described by referring to the flowchart of FIG. 5.

In step SS1, the data packet is received from the WANside interface unit 33. Four items of information are then extracted from the received data packet, including the source IP address of the IP header (SIP), the destination IP address of the IP header (DIP), the source port number of the TCP/UDP header (SPT) and the destination port number of the TCP/UDP header (DPT).

In step SS2, the access control unit 33 determines whether there is an access permission entry with the ASIP, ADIP, ASPT and ADPT which are identical to the SIP, DIP, SPT and DPT, respectively, by referring to the access permission list stored in the storage unit 35. Depending on the result of the confirmation, it is decided whether the received packet should be permitted or rejected for passage.

If not every field agrees, the passage of the data packet is not permitted and instead the data packet is disposed of in step SS3.

On the other hand, if there is an access permission entry with all the corresponding fields, the passage of the received data packet is permitted. In this case, the current time is stored in the last access permission time field (LATM) of the relevant access permission entry in step SS4. The current time here means, e.g., the time indicated by a time management unit which is usually called the system clock, managed by the operating system (OS) of the gateway 30.

In step SS5, after renewing the last access permission time field, the received data packet is transferred to the address conversion unit 32. In the address conversion unit 32, the global IP address in the IP header of the data packet is converted into the local IP address used within the local network 20 and then transferred to the LAN-side interface unit 34.

Specifically, the DIP and the DPT, for example, are converted into the local IP address and port number, respectively, of the device which is actually providing the services on the local network 20. The converted data packet is transmitted to the local network 20 via the LAN-side interface unit 34 and transferred onto the device which provides the actual services.

Thus, when the device on the global network 10 tries to access the services provided on the local network 20, the information about the source and destination IP addresses and the source and destination port numbers contained in the IP header and TCP/UDP header of the data packet received by the gateway 30 are extracted. The thus extracted information are compared with the access permission list stored in the storage unit 35. Based on the result of the comparison, it is determined whether access should be granted or denied. If the access is denied, the data packet is abandoned. On the other hand, if the access is granted, the destination of the data packet is converted into the local IP address of the device providing the services on the local network 20, so that the data packet can be transferred to the local network 20 via the LAN-side interface unit 34.

Thus, when the device on the global network 10 tries to access the services provided on the local network 20, access is granted only when the device is authenticated and the access requests from the other devices are rejected. Accordingly, the firewall security can be improved and illegal access requests can be rejected. Furthermore, since access is granted to the authenticated device, authorized users can be provided with highly convenient services.

As described above, the access permission list comprising the access permission entry for the authorized access is stored in the storage unit 35. In the gateway 30, it is determined whether the received data packet should be transmitted to the local network 20 based on the access permission list and the IP header and TCP/UDP header information in the received data packet. Whenever access is established, a new access permission entry is created for that access and added to the access permission list. Therefore, the volume of the access permission list increases as the number of access increases. Further, as the access permission entries are left in the access permission list, the access permission entry associated with a once-authenticated access remains permanently in the access permission list in the storage unit 35 even after the access is terminated, which gives rise to a security concern. Accordingly, it is necessary to eliminate at appropriate intervals the access permission entries associated with terminated accesses.

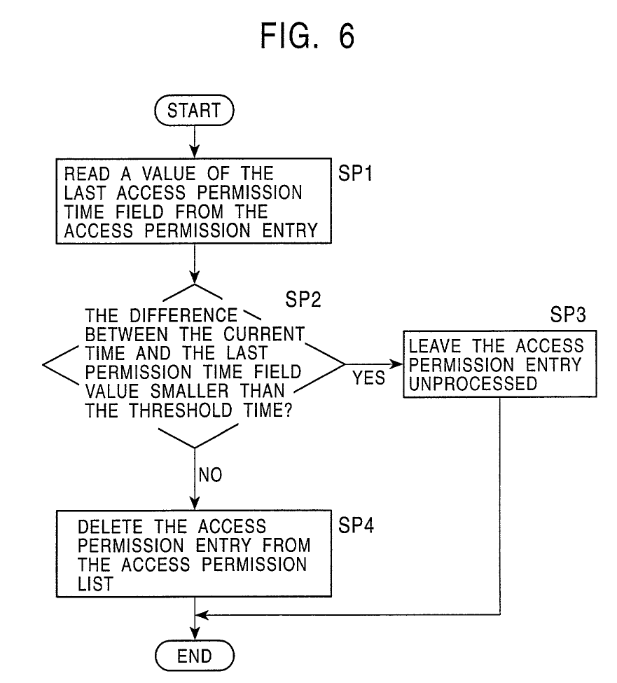

Hereafter, the process of eliminating the access permission entry based on the last access permission time and the threshold time will be described by referring to the flowchart of FIG. 6.

During the elimination processing, a time t_{D} which elapsed from the last access permission time to the current time (when a decision is made) is compared with a predetermined threshold time T_{S}. When the elapsed time t_{D} exceeds the threshold time Tₛ, the relevant access permission entry is eliminated from the access permission list. Namely, if there was no new access made after a passage of a certain duration of time since the last access, the permission for the last access is eliminated. The elimination processing is performed for each and every entry in the access permission list at predetermined time intervals.

As shown in FIG. 6, a value t_{f} of the last access permission time field (LATM) is read from the access permission entry in step SP1.

In step SP2, a difference between the current time t and the time t_{f} read from the last access permission time field, i.e., the time t_{D} (=t−t_{f}) which elapsed from the last access permission time up to the present time, is calculated, and the elapsed time t_{D} is compared with the threshold time Tₛ.

In step SP3, if the elapsed time t_{D} is smaller than the threshold time Tₛ, no processing is performed on the access permission entry.

If the elapsed time t_{D} is equal to or greater than the threshold time Tₛ, the access permission entry is eliminated from the access permission list in step SP4.

Thus, the access permission entry is eliminated from the access permission list when the elapsed time t_{D} from the last access time exceeds the predetermined threshold time Tₛ. In other words, the access permission entry is eliminated if there was no access within a predetermined duration of time after the last access was made on the assumption that the relevant access was terminated.

The threshold time Tₛ may be set at different values for different access permission entries. For example, the threshold time Tₛ for an access permission entry concerning an access to a WWW server may be set shorter than the threshold time Tₛ for an access permission entry concerning the Telnet or the FTP.

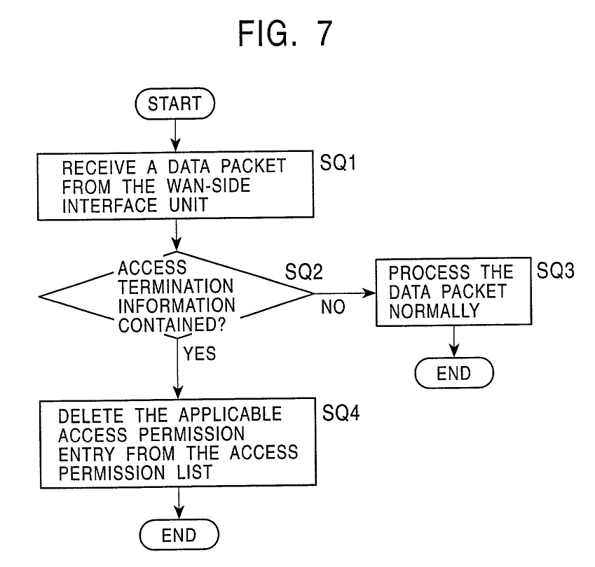

FIG. 7 shows a flowchart of the processing for eliminating from the access permission list an access permission entry created for a particular access upon receiving a notice of access termination from the accessing party.

As shown, a data packet is received from the WAN-side interface unit 33 in step SQ1. Next, it is determined in step SQ2 whether the received data packet contains information indicating the termination of access (to be hereafter called “access termination information”).

If there is no access termination information contained, the data packet is processed normally in step SQ3. On the other hand, if the access termination information is contained in the data packet, the access permission entry corresponding to the relevant access is eliminated from the access permission list in step SQ4.

Thus, if the received data packet contains the access termination information, the access permission entry created in response to the establishment of access is eliminated from the access permission list. Accordingly, when the device on the global network 10 notifies access termination, the access permission entry which had been created at the time when access was established is eliminated from the access permission list as soon as the relevant access is terminated. This ensures that the entry will not be misused and that the security of the entire system can be improved.

Since the gateway 30 has only so much resources, the access permission list can store only so many access permission entries. This problem can be overcome by eliminating one of the access permission entries with the oldest value of the last access permission time from the retained access permission list when a newly created access permission entry is to be added while the access permission list is full.

While only two examples of the entry elimination processing in the embodiment of the network connection control apparatus according to the present invention, i.e. the gateway 30, were described above, they are not to be taken as limiting the scope of the present invention. For example, access may be forcibly terminated by a decision made in the gateway 30, or by a decision made in the device actually providing the services on the local network.

Thus, in accordance with the network connection control apparatus and method according to the present invention, the firewall-function equipped gateway grants access to the services provided on the local network only to the authenticated device on the global network. This enables authorized users of the network to easily access services provided on a particular local network via a network available to them where they have traveled to, while denying access to the unauthorized users by the setting of the firewall function of the gateway. Thus, the security level on the local network can be highly maintained.

What is claimed is:

1. A network connection control apparatus for granting or rejecting access when a device on a global network demands access to services provided on a local network, comprising:
authentication means for authenticating the device on said global network;
access permission entry creating means for creating an access permission entry in response to an access request from the device authenticated by said authentication means, and adding said access permission entry to an access permission list; and
control means which, upon receiving a data packet sent from the device on said global network, determines whether or not said data packet should be transferred to said local network based on information extracted from the header of said data packet and on the access permission entry contained in said access permission list.

2. A network connection control apparatus according to claim 1, wherein said access permission entry creating means extracts access information from an access request packet transmitted from the authenticated device, thereby creating an access permission entry containing a source IP address, a destination IP address, a source port number, a destination port number and a last access permission time.

3. A network connection control apparatus according to claim 1, wherein said control means extracts a source IP address, a destination IP address, a source port number and a destination port number from the header of the data packet transmitted from the device on said global network, compares these extracted items of information with the information about the access permission entry contained in said access permission list, and transfers said data packet to said local network if the two pieces of information correspond in all of the source IP address, destination IP address, source port number and destination port number.

4. A network connection control apparatus according to claim 1, wherein said control means eliminates the access permission entry corresponding to a relevant access from said access permission list in accordance with an access termination notification from the device on said global network.

5. A network connection control apparatus according to claim 1, wherein said control means calculates the length of time which elapsed from the last access based on a last access permission time stored in the access permission entry which corresponds to the time at which the data packet was received from the device on said global network, and eliminates the access permission entry from said access permission list when the elapsed time exceeds a predetermined reference time.

6. A network connection control apparatus according to claim 1, further comprising storage means for storing said access permission list.

7. A network connection control method for granting or rejecting access when a device on a global network demands access to services provided on a local network, comprising the steps of:
authenticating the device on said global network;
creating an access permission entry in response to an access request from the authenticated device and adding the access permission entry to an access permission list;
determining, upon receiving a data packet from a device on said global network, whether or not said data packet should be transferred to said local network based on information extracted from the header of said data packet and on the access permission entry contained in said access permission list.

8. A network connection control method according to claim 7, wherein, in the step of creating the access permission entry, access information is extracted from an access request packet transmitted from the authenticated device, so that an access permission entry can be created which contains a source IP address, a destination IP address, a source port number, a destination port number and a last access permission time.

9. A network connection control method according to claim 7, wherein a source IP address, a source port number, a destination IP address and a destination port number are extracted from the header of the data packet transmitted from the device on said global network, and the extracted items of information are compared with information about the access permission entry contained in said access permission list, whereby said data packet is transferred to said local network if the two pieces of information correspond in all of the source IP address, destination IP address, source port number and destination port number.
